(19) United States
(12) Patent Application Publication
(10) Pub. No.: US 2008/0242196 A1
(43) Pub. Date: Oct. 2, 2008

(54) METHOD AND SYSTEM FOR CONTROLLING CHEMICAL MECHANICAL POLISHING BY TAKING ZONE SPECIFIC SUBSTRATE DATA INTO ACCOUNT

(76) Inventors: Gerd Marxsen, Radebeul (DE); Uwe Stoeckgen, Dresden (DE); Jens Heinrich, Wachau (DE); Alexander Hoefgen, Oberlichtenau (DE)

Correspondence Address: WILLIAMS, MORGAN & AMERSON, 10333 RICHMOND, SUITE 1100, HOUSTON, TX, 77042, US

(21) Appl. No.: 11/943,167

(22) Filed: Nov. 20, 2007

(30) Foreign Application Priority Data
Mar. 30, 2007 (DE) 10 2007 015 503.6

(51) Int. Cl. B24B 49/00; G06F 19/00

(52) U.S. Cl. 451/8; 451/37; 700/164

(57) ABSTRACT

A system for chemical mechanical polishing (CMP) is disclosed which includes a polishing apparatus for polishing a surface of a substrate and a sensor for determining zone-specific substrate data respectively related to at least two zones of the substrate. A controller is provided for generating, in response to the zone-specific substrate data, at least one set-point value, e.g., a set-point window of values for at least one operating parameter of the polishing apparatus in a subsequent CMP process. The set-point value/set-point window of values may be displayed on a display device or automatically taken into account by the controller for controlling subsequent CMP processes.

### BACKGROUND OF THE INVENTION

1. Field of the Invention

The subject matter disclosed herein relates to the field of fabrication of microstructures, and, more particularly, to a tool for chemically mechanically polishing substrates, bearing, for instance, a plurality of dies for forming integrated circuits, wherein the system is equipped with a sensor for determining substrate data.

2. Description of the Related Art

In microstructures such as integrated circuits, a large number of elements, e.g., transistors, capacitors and resistors, are fabricated on a single substrate by depositing semi-conductive, conductive and insulating material layers and patterning those layers by photolithography and etch techniques. Frequently, the problem arises that the patterning of a subsequent material layer is adversely affected by a pronounced topography of the previously formed material layers. Moreover, the fabrication of microstructures often requires the removal of excess material of a previously deposited material layer. For example, individual circuit elements may be electrically connected by means of metal lines that are embedded in a dielectric, thereby forming what is usually referred to as a metallization layer. In modern integrated circuits, a plurality of such metallization layers are typically provided, wherein the layers are stacked on top of each other to maintain the required functionality. The repeated patterning of material layers, however, creates an increasingly non-planar surface topography, which may cause deterioration of subsequent patterning processes, especially for microstructures including features with minimum dimensions in the submicron range, as is the case for sophisticated integrated circuits.

It has thus turned out to be necessary to planarize the surface of the substrate between the formation of specific subsequent layers. A planar surface of the substrate is desirable for various reasons, one of them being the limited optical depth of the focus in photolithography which is used to pattern the material layers of microstructures.

Besides the planarization, polishing of the wafer is necessary, e.g., for the formation of copper interconnects in integrated circuits. While the widely used aluminum may be structured by etching, the lack of low temperature volatile copper compounds requires a different technique for structuring copper interconnects. In order to provide a desired pattern of the copper interconnects, trenches and via holes are etched into the interlayer dielectric, are coated with an appropriate barrier layer to avoid copper diffusion and are subsequently filled with copper. Since the deposited copper also covers the regions between the trenches, the wafer has to be polished down to the interlayer dielectric to remove the excess copper. By this so-called damascene process, well-defined copper interconnects are formed within the interlayer dielectric.

The polishing process is usually a chemical mechanical polishing (CMP) process. CMP is an appropriate and widely used process to remove excess material and to achieve global planarization of a substrate. In the CMP process, a wafer is mounted on an appropriately formed carrier, a so-called polishing head, and the carrier is moved relative to a polishing pad while the wafer is in contact with the polishing pad. A slurry is supplied to the polishing pad during the CMP process and contains a chemical compound reacting with the material or materials of the layer to be planarized by, for example, converting into a reaction product that may be less stable and easier removed, while the reaction product, such as a metal oxide, is then mechanically removed with abrasives contained in the slurry and/or the polishing pad. To obtain a required removal rate, while at the same time achieving a high degree of planarity of the layer, parameters and conditions of the CMP process must be appropriately chosen, considering factors such as construction of the polishing pad, type of slurry, pressure applied to the wafer while moving relative to the polishing pad and the relative velocity between the wafer and the polishing pad. The removal rate further significantly depends on the temperature of the slurry, affected by the amount of friction created by the relative motion of the polishing pad and the wafer, the degree of saturation of the slurry with ablated particles and, in particular, the state of the polishing surface of the polishing pad.

Most polishing pads are formed of a cellular microstructure polymer material having numerous voids which are filled with slurry during operation. A densification of the slurry within the voids occurs due to the absorbed particles that have been removed from the substrate surface and accumulated in the slurry. As a consequence, the removal rate steadily decreases, thereby disadvantageously affecting the reliability of the planarizing process and thus reducing yield and reliability of the completed semiconductor devices.

To partly overcome this problem, a so-called pad conditioner is typically used that “reconditions” the polishing surface of the polishing pad. The pad conditioner includes a conditioning surface that may be comprised of a variety of materials, e.g., diamond that is embedded in a resistant material. In such cases, the exhausted surface of the pad is ablated and/or reworked by the relatively hard material of the pad conditioner once the removal rate is assessed to be too low. In other cases, as in sophisticated CMP apparatuses, the pad conditioner is continuously in contact with the polishing pad while the substrate is polished.

In modern integrated circuits, process requirements concerning uniformity of the CMP process are very strict so that the state of the polishing pad has to be maintained as constant as possible over the entire area of a single substrate as well as for the processing of as many substrates as possible. Consequently, the pad conditioners are usually provided with a drive assembly and a control unit that allow the pad conditioner, that is, at least a carrier including the conditioning surface, to be moved with respect to the polishing head and the polishing pad to rework the polishing pad substantially uniformly while avoiding interference with the movement of the polishing head. Therefore, one or more electric motors are typically provided in the conditioner drive assembly to rotate and/or sweep the conditioning surface suitably.

One problem with conventional CMP systems resides in the fact that a wafer removal profile, as well as a wafer removal rate, depends on many factors, e.g., the type of slurry, the slurry thickness, the temperature of the slurry, the pressure applied to the wafer while moving relative to the polishing pad, the relative velocity between the wafer and the polishing pad, the curvature of the wafer, etc. Controlling a conventional CMP system therefore requires complex controlling of multiple parameters. Moreover, the deterioration of one or more of the consumables of a CMP renders it difficult to maintain process stability and to reliably predict an optimum time point for consumable replacement.

Generally, replacing the consumables at an early stage significantly contributes to the cost of ownership and a reduced tool availability, whereas a replacement in a very advanced stage of the consumables of a CMP system may jeopardize process stability. Further, specifically for large substrates, the cost for process adjustments and windowing, i.e., providing an acceptable range of values for the process parameters, is high.

The present disclosure is directed to various systems and methods that may avoid, or at least reduce, the effects of one or more of the problems identified above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

Generally, the subject matter disclosed herein is directed to a technique for controlling a CMP system on the basis of at least one process parameter, a set-point or process window of which is generated by a control system on the basis of zone-specific substrate data. To this end, a process parameter may be any parameter which is related or which affects the chemical mechanical polishing, e.g., a type of slurry, a slurry thickness, a temperature of the slurry, a slurry distribution over the polishing pad, a pressure applied to the wafer while moving relative to the polishing pad, a relative velocity between the wafer and the polishing pad, a curvature of the wafer, a wafer removal profile, a desired endpoint of polishing, a friction coefficient of the polishing pad, etc.

A system for chemical mechanical polishing comprising a polishing apparatus for polishing a surface of a substrate is disclosed. A sensor is provided for determining a zone-specific substrate data respectively related to at least two zones of the substrate. A controller generates, in response to the zone-specific substrate data, at least one set-point value for at least one operating parameter of the polishing system in a subsequent CMP process.

A system for chemical mechanical polishing comprising a controllably movable polishing head configured to receive and hold in place a substrate and a sensor for determining a zone-specific substrate data respectively related to at least two zones of the substrate is disclosed. A storage for storing the zone-specific substrate data is provided. The system further includes a controller for providing, in response to stored zone-specific substrate data, at least one set-point value for at least one operating parameter of the chemical mechanical polishing system after the polishing of the substrate.

An illustrative method of operating a chemical mechanical polishing (CMP) system is disclosed which comprises taking into account zone-specific data respectively related to at least two zones of a substrate and, in response to the zone-specific data, generating at least one set-point value for at least one operating parameter of the chemical mechanical polishing system.

### BRIEF DESCRIPTION OF THE DRAWINGS

The disclosure may be understood by reference to the following description taken in conjunction with the accompanying drawings, in which like reference numerals identify like elements, and in which:

FIG. 1 shows a sketch of an embodiment of a substrate with indicated substrate zones;

FIG. 2A shows a sketch of a CMP system according to illustrative embodiments disclosed herein;

FIG. 2B shows an elevated view of the polishing pad of the CMP system shown in FIG. 2A;

FIG. 2C shows a cross-sectional sketch of a polishing head of the CMP system shown in FIG. 2A;

FIG. 3 schematically shows the CMP system according to further illustrative embodiments disclosed herein;

FIG. 4 schematically shows a CMP system according to still other illustrative embodiments disclosed herein;

FIG. 5 schematically shows, in part, a cross-sectional sketch of a CMP system according to still other illustrative embodiments disclosed herein;

FIG. 6 represents a plot of a sensor signal, representing an endpoint signal versus polish time; and

FIG. 7 schematically shows a substrate indicating individual devices, as well as different substrate zones, according to illustrative embodiments disclosed herein.

While the subject matter disclosed herein is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Various illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present subject matter will now be described with reference to the attached figures. Various structures, systems and devices are schematically depicted in the drawings for purposes of explanation only and so as to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

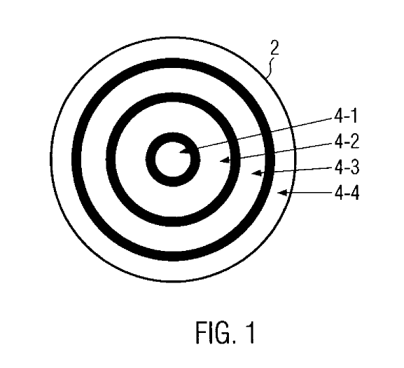

Chemical mechanical polishing (CMP) processes are common in state of the art semi-conductor technology. According to one aspect, zone-specific substrate data are determined and taken into account for the present CMP process or for subsequent CMP processes, wherein the specific substrate data are respectively related to at least two zones of a substrate. FIG. 1 shows an exemplary embodiment of a substrate, two different zones of which are indicated at 4-1, 4-2, 4-3, 4-4. In the illustrative embodiment, the zones under consideration are ring-shaped. According to other embodiments, the zones under consideration may take any other suitable shape. It should be understood that the zones 4-1, 4-2, 4-3, 4-4 are not marked at the substrate but merely indicate different zones which may be treated separately when evaluating substrate data.

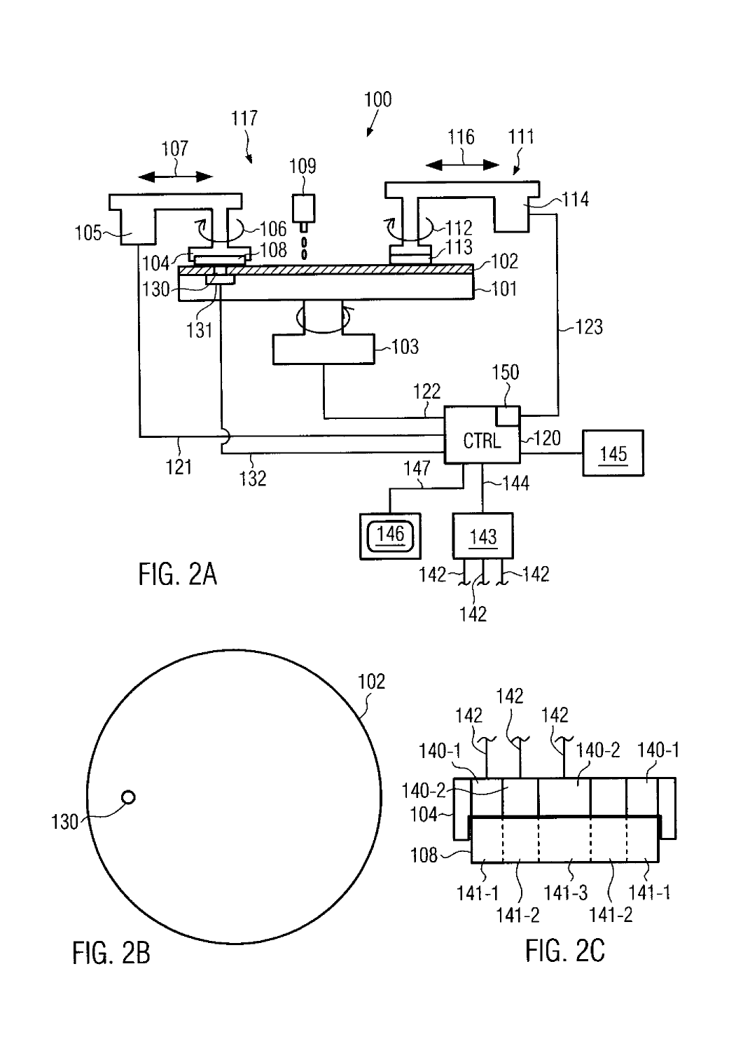

FIG. 2A schematically represents an illustrative CMP system 100 in accordance with the present disclosure. The CMP system 100 comprises a platen 101 on which a polishing pad 102 is mounted. The platen 101 is rotatably attached to a drive assembly 103 that is configured to rotate the platen 101 at any desired revolution between a range of a few to some hundred revolutions per minute. A polishing head 104 is coupled to a drive assembly 105, which is adapted to rotate the polishing head 104, indicated at 106, and to move the polishing head 104 as a whole with respect to the platen 101, as is indicated by 107. Furthermore, the drive assembly 105 may be configured to move the polishing head 104 in any desired manner necessary to load and unload a substrate 108, which is received and held in place by the polishing head 104. Slurry supply 109 is provided and positioned such that a slurry 110 may be appropriately supplied to the polishing head 102.

The CMP system 100 further comprises a conditioning system 111, which will also be referred to herein as pad conditioner 111, including a head 112 attached to which is a conditioning member 113 including a conditioning surface comprised of an appropriate material, such as diamond, having a specified texture designed to obtain an optimum conditioning effect on the polishing pad 102. The head 112 of the pad conditioner 111 is connected to a drive assembly 114 which, in turn, is configured to rotate the head 112, indicated at 115, and/or move the head 112 as a whole with respect to the platen 101, as is indicated by the arrow 116. Moreover, the drive assembly 114 of the pad conditioner 111 may be configured to provide the head 112 with any movability required for yielding the appropriate conditioning effect.

The drive assemblies described herein, for example the drive assembly 103, 105, 114, each comprise at least one motor, typically an electric motor, of any appropriate construction to impart the required functionality to the respective driven element, e.g., the platen 101, in the substrate holding head 104 or the head 112 of the pad conditioner 111. For instance, the electric motor may include any type of DC or AC servo motor.

The CMP system 100 illustrated in FIG. 2A further comprises a controller (CTRL) 120 which is operatively connected to the drive assemblies 103, 105 and 114. The controller 120 may also be connected to the slurry supply 109 to initiate slurry dispense. The controller 120 may be comprised of two or more sub-units that may communicate with appropriate communication networks, such as cable connections, wireless networks and the like. For instance, the controller 120 may comprise a sub-control unit as is provided in conventional CMP systems so as to appropriately provide control signals 121, 122, 123 to the drive assemblies 105, 103, 114, respectively, to coordinate the movement of the polishing head 104, the polishing head 102 and the pad conditioner 111. The control signals 121, 122, 123 may represent any suitable signal formed to instruct corresponding drive assemblies to operate at the required rotational and/or transitory speeds.

During the operation of the CMP system 100, the substrate 108 may be loaded onto the polishing head 104, which may have been appropriately positioned so as to receive the substrate 107 and convey it to the polishing head 102. It should be noted that the polishing head 104 typically comprises a plurality of gas lines supplying vacuum and/or gases to the polishing head 104 to fix the substrate 108 and to provide a specific downforce during the relative motion between the substrate 108 and the polishing pad 102. The various functions required for properly operating the polishing head 104 may also be controlled by the controller 120, or a sub-control unit thereof. The slurry supply 109 is actuated, for example, by the controller 120, to supply the slurry 110 that is distributed across the polishing head 102 upon rotating the platen 101 and the polishing head 104. The control signals 121 and 122 supplied to the drive assemblies 105, 103, respectively, effect a specified relative motion between the substrate 107 and a polishing pad 102 to achieve a desired removal rate of a material of the substrate 107 which depends, as previously explained, amongst others, on the characteristics of the substrate 107 and the construction and current status of the polishing head 102, the type of slurry 110 used and the downforce applied to the substrate 108. Prior to and/or during the polishing of the substrate 108, the conditioning member 113 is brought into contact with the polishing pad 102 to rework the surface of the polishing pad 102. To this end, the head 112 is rotated and/or otherwise moved across the polishing pad 102 wherein, for example, the controller 120 provides the respective control signal 123 to the drive assembly 114. Depending on the status of the polishing pad 102 and the conditioning surface of the member 113, for a given type of slurry 110, a frictional force acts and requires a specific amount of motor torque to maintain the specified constant rotational speed of the head 112.

Contrary to the frictional force acting between the substrate 108 and the polishing pad 102, which may significantly depend on substrate specifics and may, therefore, greatly vary during the polishing process of a single substrate, the frictional force between the conditioning member 113 and the polishing pad 102 is substantially determined by a status of the polishing pad 102, conditioning member 113 and other consumables. For instance, during the progress of the conditioning process for a plurality of substrates 108, a sharpness of the surface texture of the conditioning member 113 may deteriorate, which may lead to a decrease of the frictional force between the pad 102 and the conditioning member 113. Consequently, the motor torque and thus the motor current required to maintain the rotational speed of the head 112 constant also decreases. Thus, the value of the motor torque conveys information on the frictional force between the conditioning member 113 and the polishing pad 102 and depends on the status of at least the conditioning member 113.

As mentioned above, the frictional force acting between the substrate 108 and the polishing pad 102 may significantly depend on substrate specifics. This varying frictional force may, therefore, be taken into account to determine information about the status of the substrate 108 and hence of the polishing process. However, the frictional force between the substrate 108 and the polishing pad 102 does not give specific information about different zones of the substrate. Accordingly, according to an aspect disclosed herein, the polishing pad comprises an opening 130 which allows a platen-related sensor 131 to determine zone-specific substrate data related to at least two zones of the substrate 108. As illustrated in FIG. 2B, which shows a top view of the polishing pad 102, the opening 130 may take the shape of a circular hole. Different zones of the substrate 108 may be investigated through the circular hole by the relative motion of the platen 101 and the substrate 108, the relative motion effected by the drive assemblies 105, 103. To this end, the sensor signals 132, which are provided by the sensor 131, are correlated with the control signals 121, 122 by the controller 120 in order to obtain zone-specific substrate data. In the following, the thus obtained zone-specific substrate data are referenced by 132.

According to other embodiments, more than one platen-related sensor 131 may be provided. For example, the two or more platen-related sensors 131 may be distributed over a platen radius or may be distributed along an arcuated path about an axis of rotation of the platen 101. Again, the sensor signals of the platen-related sensors 131 may be correlated with relative movement of the platen 101 and the polishing head 104. The zone-specific substrate data 132 may be any substrate data which characterizes the status of the substrate and which may be determined selectively for the zones under consideration. According to one illustrative embodiment, the zone-specific substrate data 132 are substrate data which are suitable for an endpoint detection of the polishing process. For example, the zone-specific substrate data 132 may be electrical substrate data such as conductivity, capacitance or impedance. Further, the zone-specific substrate data 132 may be acoustic data, for example, a sound velocity in the respective zone of the substrate. Further, zone-specific substrate data 132 may be optical data, e.g., scattering data or reflectance data of the respective zones of the substrate, for example, reflectance data may be data related to the wafer in terms of intensity or spectroscopy. Further, zone-specific substrate data 132 may be a layer thickness of a layer to be polished. Still further, zone-specific substrate data 132 may be dishing data or erosion data. Dishing is related to a recess height of a metal layer compared to the neighboring oxide layers, e.g., interlayer dielectric layers. Erosion is related to a height of a polished oxide, e.g., interlayer dielectrics, measured from its original height. Besides the given examples of zone-specific substrate data, any other zone-specific substrate data may be taken into account. Zone-specific substrate data taken into account for further processing as described herein may be zone-specific substrate data which indicates uniformity of these data over the substrate. Additionally or alternatively, zone-specific substrate data taken into account for further processing as described herein may be zone-specific substrate data that indicates non-uniformity of these data over the zones of the substrate.

In response to the zone-specific substrate data, at least one set-point value for at least one operating parameter of the polishing system 100, e.g., at least one set-point value for at least one operating parameter of the polishing apparatus 117, is generated by the controller 120 or a sub-controller thereof. The controller 120 may be configured to discriminate whether the zone-specific data indicates uniformity or non-uniformity of the substrate over the zones with regard to these data. According to one aspect of the present subject matter, zone-specific data may be taken into account by the controller 120 weighted with a degree of uniformity. For example, if zone-specific substrate data indicates a high uniformity over the zone with respect to these data, in a statistical analysis, the operating parameters which have led to these determined zone-specific substrate data are taken into account by the controller with a higher weight and vice versa. An operating parameter of the polishing apparatus may be, for example, the pressure by which the substrate 108 is pressed onto the polishing pad 102. An operating parameter of the polishing apparatus may be a zone-specific pressure by which different zones of the substrate 108 are pressed onto the polishing pad 102. Another operating parameter may be the relative velocity between the substrate 108 and the polishing pad 102. A still further operating parameter may be the temperature of the substrate 108. A still further operating parameter may be the type of slurry used, e.g., the type of abrasive contained in the slurry, e.g., size, shape, volume fraction and hardness of the abrasive, the viscosity of the slurry, the chemicals contained in the slurry, the pH value of the slurry and the flow rate by which the slurry is supplied to the polishing pad 102. Still another operating parameter is a polishing pad related operating parameter, e.g., a pad stiffness, a pad macro-structure, a pad microstructure or a pad velocity. A further operating parameter may be the polishing duration. Further, an operating parameter may be any other parameter which is related to the polishing process and which may be controllably varied.

The at least one set-point value generated by the controller 120 may be a single set-point value or may be a process window for the respective operating parameter. According to one embodiment, the controller 120 generates the at least one set-point value for only one operating parameter. According to other embodiments, the controller 120 generates at least one set-point value for two or more of the operating parameters of the CMP system. The at least one set-point value, e.g., a set-point window which ensures a desired polishing result, generated by the controller 120 may be displayed on a display device 146, in order to assist a user to set an appropriate value of the respective process parameter(s). According to other embodiments, the controller 120 automatically sets the process parameter to the generated set-point. According to one embodiment, the controller automatically sets the respective process parameter to a value that is within a determined set-point window and which is compatible to other requirements of the CMP system.

According to an embodiment shown in FIG. 2C, the polishing head 104 comprises three ring-shaped force-exerting zones 140-1, 140-2, 140-3 for exerting a zone-specific force to three respective ring-shaped zones of the substrate. According to other embodiments, the polishing head comprises two or more force-exerting zones for exerting a zone-specific force to at least two or more respective zones of the substrate. According to one embodiment, the zones 141-1, 141-2, 141-3 of the substrate 108 corresponds to the zones of the substrate 108 for which the zone-specific substrate data 132 are determined by the sensor 131. According to other embodiments, the zones 141-1, 141-2, 141-3 defined by the force-exerting zones of the polishing head 104 differ from the zones for which the zone-specific substrate data are determined by the sensor. According to the illustrative embodiment shown in FIGS. 2A-2C, the force-exerting zones are actuated by pressurized gas which is supplied to the polishing head 104 by gas supply lines 142 connected to a gas supply 143 which is operated by the controller 120 via control signals 144. According to other embodiments, the two or more force-exerting zones are operated to exert zone-specific force to the substrate 108 by a pressurized liquid, by electromechanical transducers, etc. Any appropriate actuator may be used to build up the two or more force-exerting zones of the polishing head 104.

The controller 120 may be configured to generate failure analysis data in response to the zone-specific substrate data obtained by the sensor 131. According to one embodiment, the controller is configured to automatically generate the failure analysis data, e.g., after each acquisition of the zone-specific substrate data, or after a predetermined time period. According to other embodiments, the controller 120 is configured to generate the failure analysis data upon user request. To this end, a user interface 145 may be operatively coupled to the controller 120. The failure analysis data may be displayed on a display device 146. To this end, the controller 120 may supply respective display signals 147 to the display device 146.

According to other embodiments, the controller may be configured to generate the failure analysis data in response to the at least one set-point value generated by the controller 120. Also, in this case, the failure analysis data may be generated automatically or upon user request, as described with regard to the above-mentioned embodiments wherein the controller generates the failure analysis data in response to the zone-specific substrate data.

The CMP system may further comprise storage 150 for storing the zone-specific substrate data 132. In this case, the controller may be configured to provide the at least one set-point value in response to the zone-specific substrate data stored in the storage 150. According to one embodiment, the controller 120 is configured to provide the at least one set-point value in response to zone-specific substrate data of two or more CMP processes. The two or more CMP processes may have been performed on the same substrate or on different substrates. A possible process sequence may comprise the following. First, a first CMP process is carried out on the substrate 108. Subsequently, the substrate 108 is characterized in a measuring system and a second CMP process is subsequently carried out on the substrate 108. According to other embodiments, other process sequences are contemplated. According to the illustrative embodiment of FIG. 2A, the storage 150 is part of the controller 120. According to other embodiments, the storage 150 is operatively connected to the controller 120, e.g., by a wire data communication link or a wireless data communication link.

Generally the controller 120 may comprise a processor which provides the functionality of the controller 120. To this end, the controller 120 may comprise a computer program product which enables a processor to provide the respective functionality. A computer program product of this kind may be provided as a full release or in the form of an update of an already existing computer program product which does not yet include the functionality according to the embodiments disclosed herein. In other embodiments, the controller 120 comprises discrete electronics which provides the desired functionality of the controller 120.

It should be noted that, although according to the subject matter disclosed herein, zone-specific substrate data are determined, the controller may be configured to generate the at least one set-point value in response to the zone-specific substrate data as well as by taking into account non-zone-specific substrate data, for example, a load of the drive assembly 105 of the polishing head 104, a load of the drive assembly 114 of the pad conditioner 111 or a load of the drive assembly 103 of the platen 101. In other words, the zone-specific substrate data 132 may only be part of the data which are taken into account for generating the at least one set-point value. Examples of non-zone-specific substrate data which may be taken into account by the controller include a horizontal load on a spindle of the polishing head 104 or of the head 112 of the pad conditioner 111. A further non-zone-specific substrate data may be slurry-related data, e.g., a conductivity of the slurry which may change during polishing of a metal surface or a metal-containing surface.

In the embodiment shown in FIG. 2A, the sensor 131 is an in situ sensor which is capable of providing zone-specific substrate data during the polishing process. According to other embodiments, the sensor 131 may be an in-line sensor of an in-line sensor system, i.e., a sensor system which is capable of determining a zone-specific substrate data in-line, i.e., without taking the substrate out of the production line. According to other embodiments, the sensor 131 may be an off-line sensor of an off-line sensor system, wherein the substrate has to be taken out of the production line in order to determine the zone-specific substrate data.

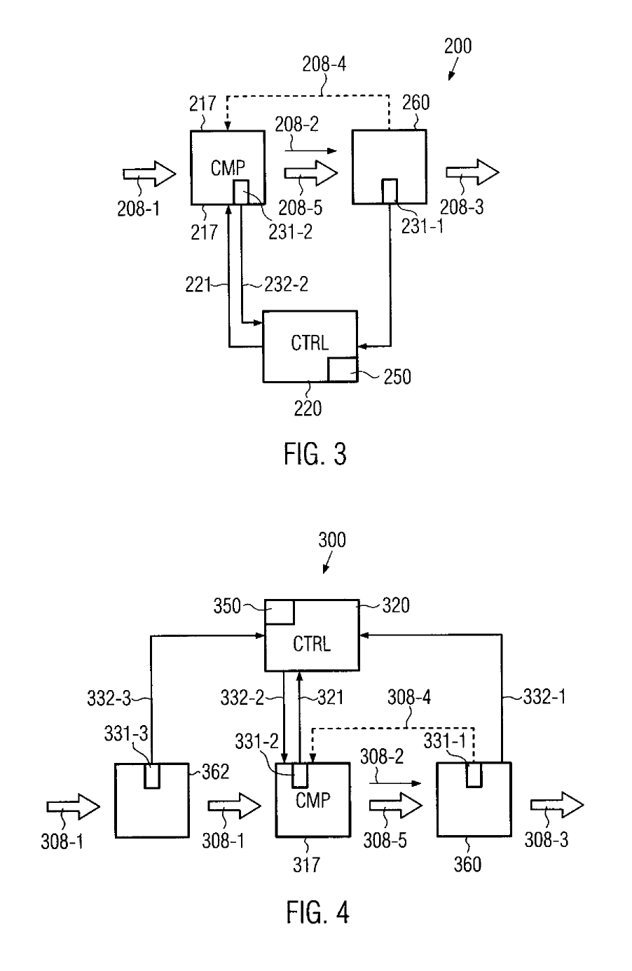

FIG. 3 shows another embodiment of a chemical mechanical polishing system 200 which comprises a CMP apparatus 217 which may be configured similar to the polishing apparatus 117 of FIGS. 2A-2C. The system 200 of FIG. 3 further comprises an in-line sensor system 260 for determining a zone-specific substrate data respectively related to at least two zones of the substrate. To this end, the in-line sensor system 260 may comprise an in-line sensor 231-1 for determining the respective zone-specific substrate data 232-1. The zone-specific substrate data 232-1 of the in-line sensor system 260 may be provided to a controller 220 via a wire data communication link or a wireless data communication link, for example. The controller 220 comprises storage 250 for storing the zone-specific substrate data 232-1. The controller 220 is configured to provide control signals 221 to the CMP apparatus 217 in order to control the operation of the polishing apparatus 217. According to one embodiment, the controller 220 is configured for generating the control signals 221 to control the operation of the polishing apparatus 217 automatically in response to the at least one operating parameter generated by the controller 220. According to other embodiments, the controller 220 displays the at least one set-point value for the at least one operating parameter on an appropriate display device (not shown) in order to propose a value or an operating window of values of the at least one operating parameter to a user which, in response to this proposal, may select an appropriate value via a user interface (not shown).

The operation of the CMP system 200 shown in FIG. 3 may be as follows. First, an incoming substrate 208-1 is provided to the CMP apparatus 217 in a polishing process carried out on the incoming wafer 208-1, thereby yielding a polished substrate 208-2 which is transferred to the in-line sensor system 260. Using the in-line sensor system 260, the polished wafer 208-2 is checked by the sensor 231-1 to thereby determine zone-specific substrate data respectively related to at least two zones of the substrate. The zone-specific substrate data 232-1 is then provided to the controller 220 which decides whether the polishing result characterized by the zone-specific substrate data 232-1 is acceptable and provides an accept-able yield of devices on the polished substrate 208-2. If the polishing result is acceptable, the polished wafer 208-2 is further processed in the production line, indicated at 208-3 in FIG. 3. Otherwise, the polished substrate 208-2 is re-transferred to the CMP apparatus 217, indicated at 208-4 in FIG. 3, wherein a further polishing process is carried out on the polished substrate 208-2. Then, the previously described process is repeated, i.e., the polished (twice polished) substrate 208-5 is transferred to the in-line sensor system 260 where the twice-polished substrate 208-5 is checked as to whether the polishing result is acceptable. In accordance with one embodiment, the zone-specific substrate data 232-1 determined by the sensor 231-1 of the in-line sensor system 260 is stored together with other process data of the polishing process in the storage 250 to thereby make available the polishing result described by the zone-specific substrate data together with the operating parameters by the application of which the substrate status corresponding to the zone-specific substrate data is produced.

Zone-specific substrate data which are taken into account for generating at least one set-point value for at least one operating parameter of the polishing system may be substrate data which are taken with regard to a first polishing process. Further, zone-specific substrate data 232-2 which are taken into account for generating at least one set-point value for at least one operating parameter of the polishing system may be substrate data which are taken with regard to a second or still further polishing process. In FIG. 3, the in-line sensor system 260 is a post-polish sensor system, wherein characteristics of the substrate are measured after CMP. In-line substrate data, e.g., post-polish substrate data, may be, for instance, any dice level substrate data, e.g., electrical or optical data on dice level. Further, in-line substrate data and, in particular, post-polish substrate data may be dishing data, erosion data, resistivity data, leakage data, etc.

It should be understood that the CMP system 200 of FIG. 3 may optionally also include an in situ sensor 231-2 which determines an in situ substrate data 232-2. The in situ sensor 231-2 may be configured similar or identical to the in situ sensor 131 of the CMP system 100 shown in FIG. 1, the description of which is not repeated here. At least one of the sensors 231-1 and 231-2 is configured for providing zone-specific substrate data.

FIG. 4 shows a CMP system 300 which differs from the CMP system 200 of FIG. 3 in that it further comprises a pre-polish sensor system 362 wherein characteristics of the substrate are measured after CMP. Pre-polish substrate data 332-3 are determined by a pre-polish sensor 331-3 of the pre-polish sensor system 362. In other embodiments, a user inter-face is provided, alternatively to the pre-polish sensor system 362 or in addition to the pre-polish sensor system 362, for inputting at least one of the pre-polish substrate data. Pre-polish substrate data 332-3 may include at least one of substrate curvature, pattern uniformity at different levels, e.g., at dice level or at substrate level, the kind of materials to be polished, etc. For instance, pre-polish substrate data, like materials to be polished, may be inputted via the user interface.

The CMP system 300 further includes an in situ sensor 331-2 of the CMP apparatus 317. The in situ sensor 331-2 determines in situ substrate data 332-2 of the substrate 108. The CMP system 300 further comprises a post-polish sensor system 360 including a post-polish sensor 331-1 for determining post-polish substrate data 332-3. The CMP apparatus 317, the in situ sensor 331-2, the post-polish sensor system 360 and the post-polish sensor 331-1 of the CMP system 300 may be similar or identical to the respective components of the CMP system 200 and the description thereof is not repeated here in detail. The controller 320 of the CMP system 300 is configured for generating at least one set-point value for at least one operating parameter of the polishing system 300 in response to the pre-polish data 332-3, the in situ data 332-2 and the post-polish data 332-1. Herein, sensor data of at least one sensor 331-1, 331-2, 331-3 is zone-specific substrate data.

An operation of the CMP system 300 may be as follows. First, an incoming substrate 308-1 is supplied to the pre-polish sensor system 362 where pre-polish data 332-3 of the incoming substrate 308-1 is determined. The substrate 308-1 is then transferred to the CMP apparatus 317 where it is polished according to preset operating parameters of the CMP apparatus 317, thereby yielding a polished substrate 308-2. During polishing, in situ substrate data 332-2 are determined by the in situ sensor 331-2. The polished substrate 308-2 is then transferred to the post-polish sensor system 360 for determining post-polish substrate data. If the polishing result is acceptable, the post-polish tested substrate 308-3 is further processed in the process line. If the polishing result is not acceptable, the wafer may be retransferred to the CMP apparatus 317, indicated at 308-4 in FIG. 4. After re-polishing, the re-polished substrate 308-5 is transferred to the post-polish sensor system 360 where it is determined whether further polishing is needed or whether the re-polished substrate 308-5 may be further processed in the process line.

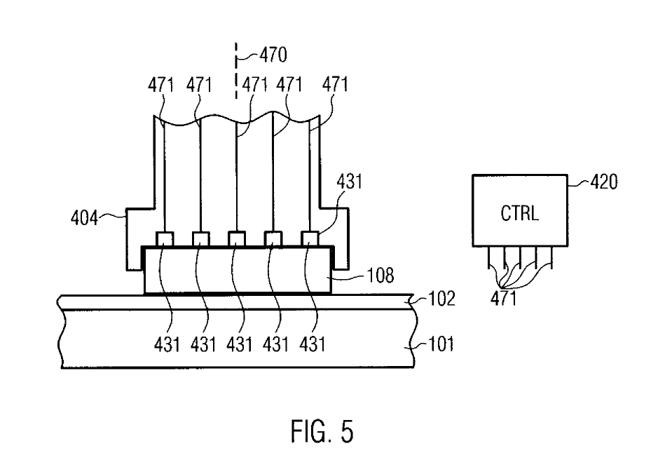

FIG. 5 shows another embodiment of a polishing head 404. The polishing head 404 is configured to receive and hold in place a substrate 108. As described in detail with regard to FIG. 5, during polishing, the polishing head 404 is moved relative to a pad 102 mounted on a platen 101. The polishing head 404 illustrated in FIG. 5 comprises a plurality, e.g., five, of radially distributed sensors 431 which have a different radial distance from the axis 470 of rotation of the polishing head with respect to each other. For example, the radially distributed sensors may be distributed over a diameter of the polishing head 404, as illustrated in FIG. 5. According to other embodiments, the radially distributed sensors are distributed over a radius of the polishing head 404. The radially distributed sensors may be, e.g., electromagnetic sensors, optical sensors, etc. Accordingly, the signal lines 471 which connect the sensors 431 to the controller 420 may be, e.g., electrical wires or optical fibers. In accordance with one embodiment, the controller 420 generates the at least one set-point for the at least one operating parameter in response to the zone-specific data obtained by the sensors 431.

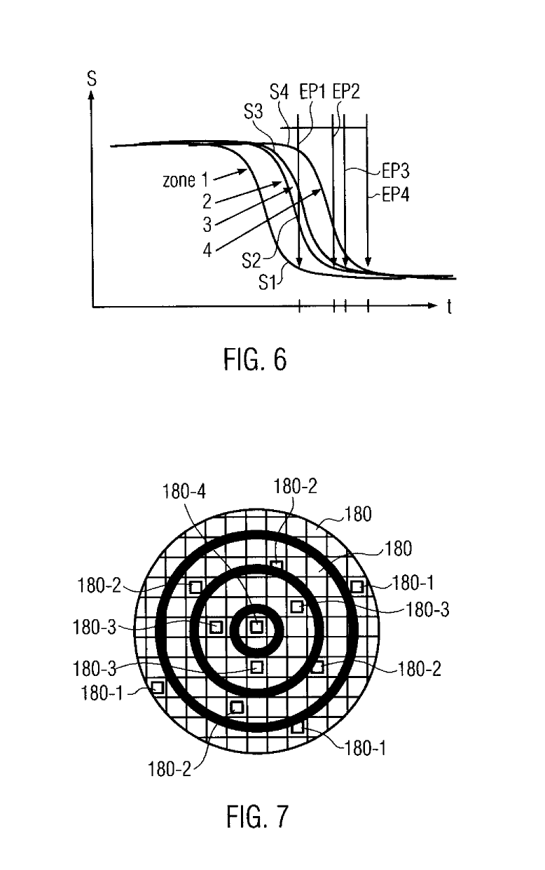

In the following, one illustrative embodiment is discussed with regard to FIG. 6. Irrespective of the method of how the zone-specific substrate data is obtained, at the end of the polishing process, there is a remaining profile of the zone-specific data over the radius of the substrate. In one illustrated embodiment, where this zone-specific substrate data is used for endpointing, different zones on the substrate would have been endpointed on different times. However, the polishing process of all zones is stopped at a certain time. The zones having different endpoint times may have seen more or less extended overpolish or under-polish. For example, in damascene technology, one of the major risks for wafer yield is local underpolish wherein some areas of the substrate (wafer) have not seen sufficient polish time to remove the required amount of metal to avoid leakage between the metal lines or features.

FIG. 6 shows an example of in situ zone-specific substrate data. In particular, FIG. 6 shows a plot of a sensor signal S, representing an endpoint signal S1, S2, S3, S4 versus polish time t for different substrate zones, e.g., the substrate zones 4-1, 4-2, 4-3, 4-4 shown in FIG. 1. The endpoint signal for the different zones indicates the endpoint of the polishing at times EP1, EP2, EP3 and EP4. In the illustrated embodiment, the polishing process is stopped at a time where the last substrate zone, 4-4 in the present case, indicated the endpoint of polishing. In this embodiment, no underpolishing, but rather only over-polishing occurs. The zone-specific overpolish times OP1, OP2, OP3, OP4 of the respective substrate zones are then calculated as follows:

OP1=EP4−EP1

OP2=EP4−EP2

OP3=EP4−EP3

OP4=0

According to one embodiment, the controller 120, 220, 320, 420 may generate, in response to the zone-specific endpoint times, a process window for the polishing time which is close to the endpoint time EP4, thereby ensuring that, under the operation conditions where the data of FIG. 6 have been determined, no underpolish of the wafer occurs. In this way, the yield can be increased without the necessity of re-polishing of the wafer due to leakage in some devices on the wafer.

FIG. 7 shows an example of post-polish zone-specific substrate data on dice level. In particular, FIG. 7 schematically shows dice regions 180 which include individual semi-conductor devices, e.g., dies. It should be noted that the dice regions 180 are not drawn to scale, but rather serve to illustrate an illustrative embodiment. The marked dice regions 180-1, 180-2, 180-3, 180-4 indicate dice regions which have a respective kind of failure or undesired properties, e.g., in terms of dishing, erosion, leakage, resistivity, etc. According to one illustrative embodiment, such post-polish zone-specific data at dice level is taken into account by the controller 120, 220, 320 for generating the at least one set-point value for at least one operating parameter of the polishing system 100, 200, 300 in response to the determined zone-specific data.

According to illustrative embodiments, the controller 120, 220, 320 may include or be operatively connected to the storage 150, 250, 350 for storing zone-specific substrate data of two or more CMP processes. Accordingly, zone-specific substrate data obtained by two or more polishing processes may be taken into account for providing the at least one set-point value for the at least one operating parameter. To this end, according to an illustrative embodiment, the operating parameters of the related CMP process are stored together with the zone-specific substrate data.

As a result, the subject matter disclosed herein provides a system and a method for enhancing the performance of a CMP system or of a process tool chain including a CMP system, since the process adjustments and windowing may be carried out faster and/or more reliable. Process adjustment and windowing may be, at least in part, carried out automatically.

A system for chemical mechanical polishing comprises a polishing apparatus for polishing a surface of a substrate and a sensor for determining zone-specific substrate data respectively related to at least two zones of the substrate. A controller is provided for generating, in response to the zone-specific substrate data, at least one set-point value, e.g., a set-point window of values for at least one operating parameter of the polishing apparatus in a subsequent CMP process. The set-point value/set-point window of values may be displayed on a display device or automatically taken into account by the controller for controlling CMP processes.

By determining zone-specific substrate data and generating in response thereto at least one set-point value for at least one operating parameter of the polishing apparatus in a subsequent CMP process, process adjustment and windowing is simplified.

The zone-specific substrate data may be pre-polish data which are obtained in advance to the polishing process, in situ data which are obtained during the polishing process or post-polish data which are obtained after the polishing process. The invention covers embodiments where zone-specific substrate data of only one of the pre-polish, in situ or post-polish regime are taken into account by the controller. Further, the invention covers embodiments where zone-specific substrate data out of two of the pre-polish, in situ or post-polish regime are taken into account by the controller. Further, the invention covers embodiments where zone-specific substrate data out of all three of the pre-polish, in situ or post-polish regime are taken into account by the controller.

A single sensor for determining zone-specific substrate data may be provided. Further, two or more sensors for determining zone-specific substrate data may be provided. In addition to the zone-specific substrate data, the controller may take non-zone-specific substrate data into account, e.g., substrate data which are averaged over the substrate.

Generally, when taking zone-specific substrate data into account, the controller may also take into account part or all of the available process parameters which characterize the polishing process by which the substrate yielding the zone-specific substrate data has been produced.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A system for chemical mechanical polishing, comprising:
a polishing apparatus for polishing a surface of a substrate;
a sensor for determining zone-specific substrate data respectively related to at least two zones of said substrate; and
a controller for generating, in response to said zone-specific substrate data, at least one set-point value for at least one operating parameter of said polishing system in a subsequent chemical mechanical polishing process.

2. The system according to claim 1, wherein said polishing apparatus has a controllably movable polishing head configured to receive and hold in place a substrate and wherein said polishing head comprises two or more force-exerting zones for exerting a zone-specific force to said at least two zones of said substrate.

3. The system according to claim 1, wherein said sensor is an in situ sensor, an in-line sensor of an in-line sensor system, or an off-line sensor of an off-line sensor system.

4. The system according to claim 1, wherein said at least two zones of said substrate are ring-shaped zones.

5. The system according to claim 1, wherein said substrate includes a plurality of individual devices and said sensor is configured to provide substrate data related to said individual devices.

6. The system according to claim 5, wherein said controller is configured to provide statistical data obtained from said substrate data related to said individual devices and to take said statistical data into account for generating said at least one set-point value.

7. The system according to claim 1, wherein providing at least one set-point value includes providing a respective process window for said at least one operating parameter.

8. The system according to claim 1, wherein said controller is configured to generate failure analysis data in response to said zone-specific substrate data and/or in response to said at least one set-point value for said at least one operating parameter.

9. The system according to claim 1, wherein said sensor is a pre-polish sensor of a pre-polish measuring system for determining pre-polish data, an in situ sensor of the polishing apparatus for determining in situ data, or a post-polish sensor of a post-polish measuring system for determining post-polish data.

10. The system according to claim 9, wherein said post-polish data include one or more of a zone-specific layer thickness of the layer to be polished, a zone-specific dishing data, a zone-specific erosion data, and a zone-specific resistivity data.

11. The system according to claim 9, wherein said in situ data include a zone-specific endpoint signal indicating the endpoint of polishing.

12. The system according to claim 1, further comprising a storage device for storing said zone-specific substrate data, wherein said controller is configured to provide said at least one set-point value in response to zone-specific substrate data of two or more CMP processes.

13. A system for chemical mechanical polishing, comprising:
a controllably movable polishing head configured to receive and hold in place a substrate;
a sensor for determining zone-specific substrate data respectively related to at least two zones of said substrate;
a storage device for storing the zone-specific substrate data; and
a controller for providing, in response to stored zone-specific substrate data, at least one set-point value for at least one operating parameter of said chemical mechanical polishing system after said polishing of said substrate.

14. A method of operating a chemical mechanical polishing system, the method comprising:
obtaining zone-specific data for at least two zones of a substrate; and
in response to said zone-specific data, generating at least one set-point value for at least one operating parameter of said chemical mechanical polishing system in a subsequent chemical mechanical polishing process.

15. The method according to claim 14, wherein generating at least one set-point value includes generating a process window for at least one operating parameter related to said chemical mechanical polishing system.

16. The method according to claim 14, wherein said zone-specific substrate data include one or more of post-polish data, in situ data and pre-polish data.

17. The method according to claim 14, wherein said substrate includes a plurality of individual devices and said zone-specific substrate data include statistical data related to said individual devices.

18. The method according to claim 14, wherein taking into account zone-specific data includes taking into account zone-specific data obtained by two or more polishing processes.
